(19) United States
(12) Patent Application Publication
(10) Pub. No.: US 2007/0254729 A1
(43) Pub. Date: Nov. 1, 2007

(54) Handheld portable electronic device with integrated stand

(76) Inventor: Joseph M. Freund, Fogelsville, PA (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/414,970

(22) Filed: May 1, 2006

(51) Int. Cl. H04M 1/00

(52) U.S. Cl. 455/575.3

(57) ABSTRACT

One embodiment of the invention is a portable electronic device having a screen block, a stand block, and hinge pivotally connecting the screen block to the stand block. The screen block has an obverse surface with a main screen. The hinge is located near one of the top, left, and right surfaces of the screen block and the corresponding surface of the stand block, and enables the portable electronic device to be in one or more closed configurations and one or more hands-free viewing configurations. The portable electronic device is adapted for handheld use and hands-free viewing, wherein it has the bottom surfaces of the screen block and the stand block resting on a substantially horizontal surface. Embodiments provide enhancements such as better hands-free viewing stability, rotating screen images, and additional features.

### BACKGROUND OF THE INVENTION

1. Field of the Invention

This invention relates generally to handheld portable electronic devices, and more particularly to handheld electronic devices with display screens, such as handheld mobile communication devices.

2. Description of the Related Art

Handheld mobile communication devices, such as cellular telephones, had originally only transmitted analog audio signals to and from the user. Subsequently, the audio signals were transmitted in digital form, and some devices also included a capability to transmit additional digital data, such as text messages. As transmission speeds increased, the potentially transmittable data grew to include emails and graphics, even including Internet web pages. As data transmission speeds continued to increase, it became possible to transmit video (e.g., short movies) to handheld mobile communication devices for either instant viewing (e.g., streaming video) or later viewing (e.g., downloaded video).

The external physical features of handheld mobile communication devices have been typically designed for comfortable handheld use. Some of the device form factors that have been developed for handheld mobile communication devices are the slab (a.k.a. monolithic) phone, the clamshell (a.k.a. flip) phone, and the sliding-pad phone. The slab phone is substantially block-like, i.e., having opposing obverse and reverse surfaces of substantially rectangular form, opposing top and bottom surfaces of substantially rectangular form, and opposing left and right surfaces of substantially rectangular form. The above substantially rectangular forms typically include corners rounded to varying extents. A typical slab phone has a main screen above the keypad, wherein both are on the obverse surface, and with the battery accessible from the reverse surface.

The sliding-pad phone is similar to the slab phone, but has a sliding section on the obverse surface. The sliding section typically incorporates the microphone such that when the sliding section slides out, the overall obverse surface is extended and the microphone is placed closer to the user's mouth. The sliding section can incorporate the keypad on its obverse surface, and can reveal a larger main screen underneath itself when slid out.

The clamshell phone comprises two substantially block-like components, the first comprising a main screen and the second comprising a keypad, hinged together such that if open, the clamshell phone substantially resembles a slab phone, but with an obtuse angle, i.e., an angle that is greater than 90 degrees and less than 180 degrees, between the component comprising the main screen and the component comprising the keypad. The battery is typically on the reverse side of the component comprising the keypad, but can also be in the reverse side of the component comprising the main screen. When the clamshell phone is closed, the screen and keypad face each other, but are not visible to the user. A secondary screen may be placed on the reverse side of the component comprising the main screen, or of the component comprising the keypad, so that the secondary screen is visible and usable when the clamshell phone is closed.

### SUMMARY OF THE INVENTION

One embodiment of the invention is a portable electronic device comprising a screen block, a stand block, and hinge pivotally connecting the screen block to the stand block. The screen block has an obverse surface comprising a main screen, a reverse surface opposing the obverse surface, opposing top and bottom surfaces, and opposing left and right surfaces. The stand block has opposing first and second surfaces opposing top and bottom surfaces, and opposing left and right surfaces. The hinge is located near one of the top, left, and right surfaces of the screen block and the corresponding surface of the stand block, and is adapted to enable the portable electronic device to be in one or more closed configurations and one or more hands-free viewing configurations. The portable electronic device is adapted for handheld use and hands-free viewing, wherein the portable electronic device is adapted to have the bottom surfaces of the screen block and the stand block resting on a substantially horizontal surface.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1A illustrates an example of a handheld mobile communication device according to one embodiment of the present invention.

FIG. 1B illustrates an alternative hands-free viewing configuration for the handheld mobile communication device of FIG. 1A.

FIG. 2 illustrates an example of a handheld mobile communication device according to a second embodiment of the present invention.

FIG. 3 illustrates an example of a handheld mobile communication device according to a third embodiment of the invention having an alternative hinge.

FIG. 4 illustrates an example of a handheld mobile communication device according to a fourth embodiment of the invention having an alternative hinge.

### DETAILED DESCRIPTION

Comfortable viewing of the main screen of previously designed handheld mobile communication devices, wherein the main screen is substantially facing the user, required that the mobile device be held in the user's hand or some other external apparatus substantially capable of orienting the main screen in a desired direction. A prior art mobile communications device unsupported by a user's hand or other external support apparatus would, if placed on a horizontal surface, lay flat on that surface, with the main screen facing directly up or down. An embodiment of the current invention provides a handheld mobile communication device with a hinged structure that allows the device to rest on a substantially horizontal surface such that the main screen is angled for relatively comfortable viewing by the user.

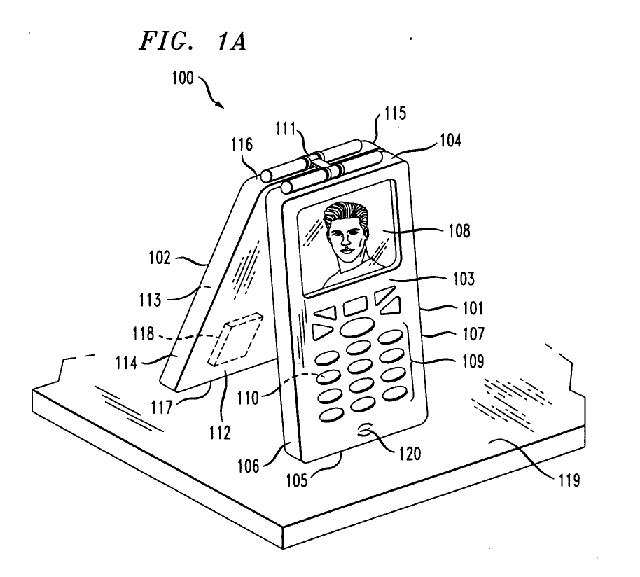

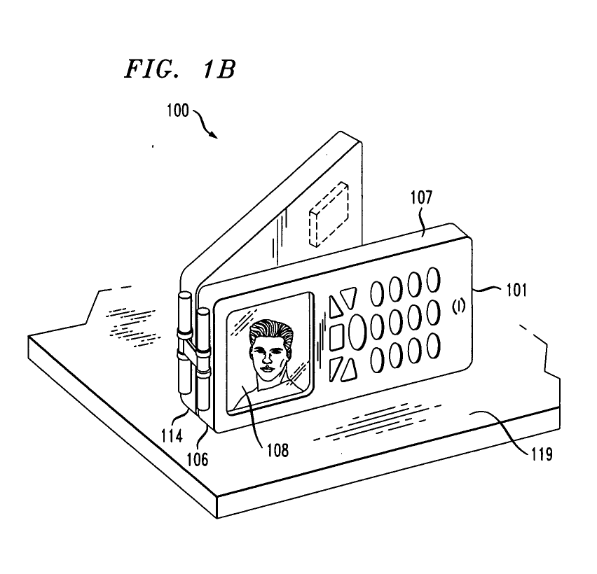

FIG. 1A shows a perspective view of handheld mobile communication device 100, according to one embodiment of the present invention, wherein the device is in a hands-free viewing configuration. Handheld mobile communication device 100 comprises screen block 101 and stand block A02, which are connected pivotally and electrically by hinge 111 near their respective tops. Innumerable hands-free viewing configurations are possible for handheld mobile communication device 100, depending on the angle between screen block 101 and stand block A02. Screen block 101 comprises main screen 108 and keypad 109 of handheld mobile communication device 100. Stand block A02 houses battery 118. In FIG. 1A, handheld mobile communication device 100 is opened to a hands-free viewing configuration, wherein an acute angle is formed between screen block 101 and stand block A02, and placed on substantially horizontal surface 119, such that the main screen is angled at a comfortable viewing angle. In a hands-free viewing configuration, housing battery 118 within stand block A02 enhances the weight distribution characteristics, and therefore the standing stability, of handheld mobile communication device 100.

Screen block 101 comprises opposing obverse and reverse surfaces 103 and 110, respectively, opposing left and right surfaces 106 and 107, respectively, and opposing top and bottom surfaces 104 and 105, respectively. Obverse surface 103 comprises main screen 108 and keypad 109. Surfaces 103, 110, 106, 107, 104, and 105 of screen block 101 are approximately rectangular, and preferably have their respective corners rounded in ways and to extents known in the art to enhance the aesthetic or practical appeal of handheld mobile communication device 100. The rounding of the surfaces may be to an extent such that one or more of the surfaces are substantially oval or round. In alternative embodiments (not shown), the surfaces may be in any suitable shape. The surfaces may also have raised or lowered sections for enhanced aesthetic appeal, practical appeal, or fit with other components. In particular, top surface 104 may have recesses and irregularities to allow it to fit with top surface 116 of stand block A02. Screen block 101 also comprises internal circuitry, such as a processor, of types as are known to one of skill in the art, to operate and control handheld mobile communication device 100.

Main screen 108 displays information provided to or by the user. The information provided on main screen 108 can include items such as: a telephone number dialed by the user, the telephone number and/or identity of an incoming caller, a text message to or from the user, system notifications sent to the user, pictures taken by or sent to the user, message graphics, game graphics, videos, and any other pictorial and/or textual images that can be shown on a screen. Keypad 109 comprises the typical telephone keypad keys, and can comprise additional operational keys, such as a power key, a connect key, a disconnect key, a menu navigation key, and a select key.

Stand block A02, which houses rechargeable battery 118, comprises opposing first and second surfaces 112 and 113, respectively, opposing left and right surfaces 114 and 115, respectively, and opposing top and bottom surfaces 116 and 117, respectively. First and second surfaces 112 and 113 are substantially the same shape as obverse and reverse surfaces 103 and 110. Surfaces 112, 113, 114, 115, 116, and 117, of stand block A02, are approximately rectangular, and preferably have their respective corners rounded in ways and to extents known in the art to enhance the aesthetic or practical appeal of handheld mobile communication device 100. The rounding of the surfaces may be to an extent such that one or more of the surfaces are substantially oval or round. In alternative embodiments (not shown), the surfaces may be in any suitable shape. The surfaces may also have raised or lowered sections for enhanced aesthetic appeal, practical appeal, or fit with other components. In particular, top surface 116 may have recesses and irregularities to allow it to fit with top surface 104 of screen block 101.

When handheld mobile communication device 100 is in a hands-free viewing configuration on substantially horizontal surface 119, as depicted in FIG. 1A, device 100 is substantially resting on bottom surface 105 of screen block 101, and on bottom surface 117 of stand block A02. Bottom surfaces 105 and 117 of screen block 101 and stand block A02, respectively, optionally incorporate pads for a softer or more stable grip of substantially horizontal surface 119.

When handheld mobile communication device 100 is in a first closed configuration, first surface 112 of stand block A02 is facing and adjacent to reverse surface 110 of screen block 101, such that main screen 108 and keypad 109 are visible and accessible. In a second closed configuration of handheld mobile communication device 100, second surface 113 of stand block 102 is facing and adjacent to obverse surface 103 of screen block 101, such that main screen 108 and keypad 109 are not accessible, and enjoy enhanced protection from stray button presses and scratches or other damage.

Hinge 111 pivotally and electrically connects screen block 101 and stand block 102. Hinge 111 allows handheld mobile communication device 100 to vary in configuration from the first closed configuration to at least one hands-free viewing configuration, to the second closed configuration. Hinge 111 further allows handheld mobile communication device 100 to maintain the above configurations, which can be achieved through use, for example, of a friction hinge, or a hinge with an internal or external stopping or holding mechanism.

In an alternative embodiment, battery 118 is a non-rechargeable battery. Non-rechargeable battery 118 may be any of the multitude of standard battery sizes available. Any standard battery housing that is known to one of ordinary skill in the art may be used to house the non-rechargeable battery.

In an alternative embodiment, battery 118 is housed in screen block 101 rather than stand block 102. In this embodiment, stand block 102 may contain other means for enhanced weight distribution, including a dead weight. If stand block 102 does not contain any electrical components, then hinge 111 does not need to provide electrical connectivity between screen block 101 and stand block 102, which allows for a simpler, less expensive hinge 111.

In an alternative embodiment, handheld mobile communication device 100 comprises integrated and/or removable nonvolatile memory (e.g., solid state nonvolatile memory, or a magnetic or optical disk drive), adapted to allow the storage, playback, and/or recording of video. The component(s) comprising the integrated and/or removable nonvolatile memory are preferably located in stand block 102 to provide enhanced weight distribution, and therefore standing stability, for handheld mobile communication device 100, but may also be located in screen block 101.

In an alternative embodiment, handheld mobile communication device 100 comprises optional devices and gadgets, such as the following: a camera adapted to capture still images and/or moving images, light sources, such as LEDs, a secondary screen for displaying information such as the current time or the identity of a caller, a microphone (e.g., microphone 120), one or more speakers, and communication ports, such as a data port and an earpiece/microphone/headphone jack.

In an alternative embodiment, keypad 109 is located on second surface 113 of stand block 102, and main screen 108 is sized to take up a larger portion of the area of obverse surface 103 of screen block 101. In a handset configuration of handheld mobile communication device 100, an obtuse angle is formed between screen block 101 and stand block 102. The image on main screen 108 is capable of rotating to an orientation 180° from its previous orientation to allow comfortable viewing of the screen when in (a) handset configuration, wherein the image on main screen 108 is rotated so that the top of the image is near bottom surface 105 of screen block 101, and (b) hands-free viewing mode, wherein the image on main screen 108 is rotated so that the top of the image is near top surface 104 of screen block 101.

In an alternative embodiment, the image on main screen 108 is capable of rotating to allow comfortable viewing of main screen 108 when (a) as illustrated in FIG. 1B, handheld mobile communication device 100 is in a hands-free viewing configuration wherein left surfaces 106 and 114 are resting on substantially horizontal support surface 119, and wherein the image on main screen 108 is rotated so that the top of the image is near right surface 107 of screen block 101, and (b) handheld mobile communication device 100 is in a hands-free viewing configuration wherein right surfaces 107 and 115 are resting on substantially horizontal support surface 119, and wherein the image on main screen 108 is rotated so that the top of the image is near left surface 106 of screen block 101. Thus, combining two alternative embodiments, the image on main screen 108 is capable of rotating to four positions, 90° apart, to allow comfortable viewing of the main screen in a handset configuration, and in three hands-free viewing configurations.

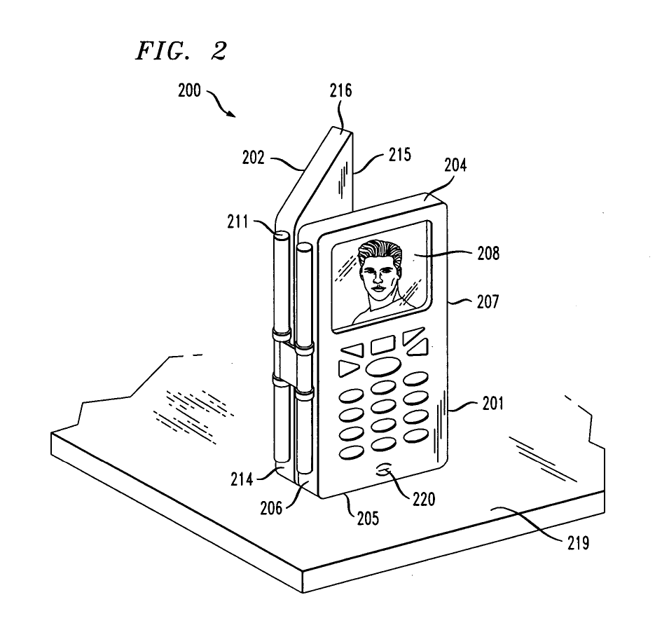

An alternative embodiment is illustrated in FIG. 2, which shows a perspective view of handheld mobile communication device 200, which is substantially similar to handheld mobile communication device 100, and wherein corresponding components are similarly labeled, but with a different prefix. In handheld mobile communication device 200, screen block 201 and stand block 202 are pivotally and electrically connected by hinge 211 substantially near their respective left surfaces, i.e., left surface 206 of screen block 201 and left surface 214 of stand block 202, such that bottom surface 205 of screen block 201 and the corresponding bottom surface of stand block 202 rest on horizontal support surface 219. In an alternative embodiment (not shown), stand block 202 is shaped such that right surface 215 is shorter than left surface 214, so that if handheld mobile communication device 200 is in an appropriate hands-free viewing configuration, screen block 201 leans backward, thus providing a more comfortable viewing angle of main screen 208. Although, in FIG. 2, screen block 201 and stand block 202 are shown connected at their left sides, in alternative embodiments, the screen block and the stand block can be pivotally and electrically connected by a hinge substantially near their respective right surfaces, in which case a more comfortable viewing angle can be provided by having the stand block shaped such that the left surface is shorter than the right surface, so that the screen block leans backward when the handheld communication device is in an appropriate hands-free viewing configuration.

In an alternative embodiment (not shown), the image on main screen 208 is capable of rotating to an orientation 90°, in either direction, from its previous orientation to allow comfortable viewing of the screen when in (a) handset configuration, wherein the image on main screen 208 is rotated so that the top of the image is near right surface 207, the surface opposite the surface of the screen block nearest to hinge 211, and (b) hands-free viewing mode, wherein the image on main screen 208 is rotated so that the top of the image is near top surface 204 of screen block 201.

In an alternative embodiment, the image on main screen 208 is capable of rotating to allow comfortable viewing of the screen when (a) handheld mobile communication device 200 is in a hands-free viewing configuration wherein top surfaces 204 and 216 are resting on substantially horizontal support surface 219, and wherein the image on main screen 208 is rotated so that the top of the image is near bottom surface 205 of screen block 201, and (b) handheld mobile communication device 200 is in a hands-free viewing configuration wherein right surfaces 207 and 215 are resting on substantially horizontal support surface 219, and wherein the image on main screen 208 is rotated so that the top of the image is near left surface 206 of screen block 201. Thus, combining two alternative embodiments, the image on main screen 208 is capable of rotating to four positions, 90° apart, to allow comfortable viewing of the main screen in a handset configuration, and in three hands-free viewing configurations. The above description also applies, with appropriate reversals, to an alternative embodiment (not shown) wherein the hinge is nearest the right surfaces of the screen block and the stand block.

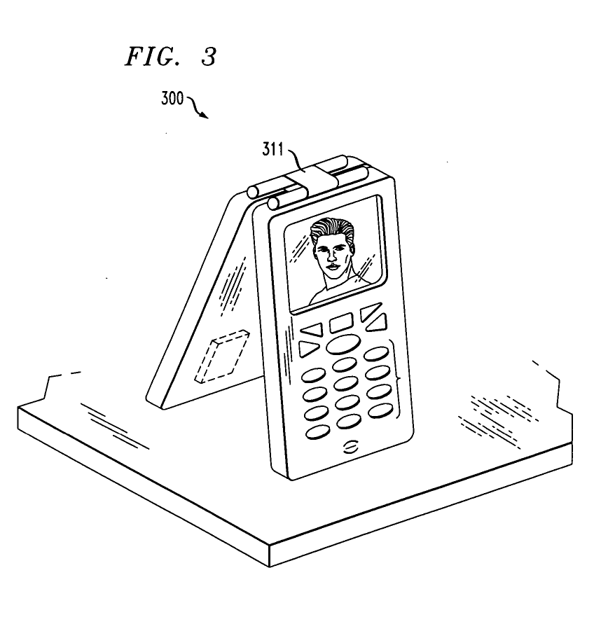

An alternative embodiment is illustrated in FIG. 3, which shows a perspective view of handheld mobile communication device 300, which is substantially similar to handheld mobile communication device 100, and wherein corresponding components are similarly labeled, but with a different prefix. FIG. 3 shows handheld mobile communication device 300, with an alternative hinge 311.

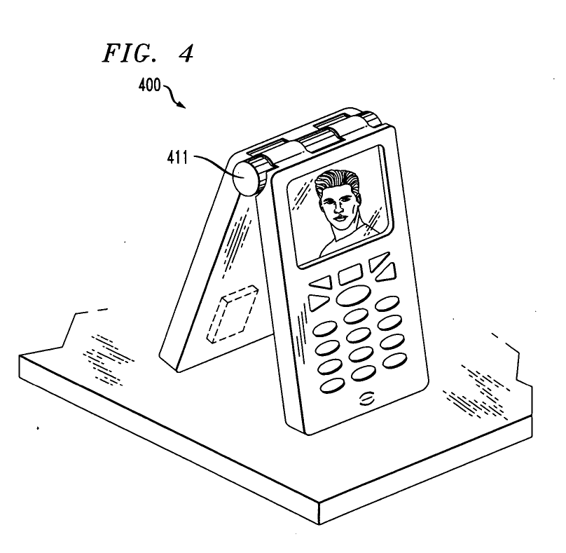

An alternative embodiment is illustrated in FIG. 4, which shows a perspective view of handheld mobile communication device 400, which is substantially similar to handheld mobile communication device 100, and wherein corresponding components are similarly labeled, but with a different prefix. As illustrated in FIG. 4, handheld mobile communication device 400 can reach the first closed configuration, from which it can open to a hands-free viewing configuration, as described above, but does not reach the second closed configuration. This embodiment may allow for the use of a simpler; less expensive hinge 411. In another alternative embodiment (not shown), the handheld mobile communication device can reach the second closed configuration, from which it can open to a hands-free viewing configuration, as described above, but does not reach the first closed configuration. This embodiment may also allow for the use of a simpler, less expensive hinge.

References in descriptions of alternative embodiments to particular figures or previously-described embodiments do not limit the alternatives to those particular shown or previously-described embodiments. Alternative embodiments described can generally be combined with any one or more of the other alternative embodiments shown or described.

Unless explicitly stated otherwise, each numerical value and range should be interpreted as being approximate as if the word “about” or “approximately” preceded the value of the value or range.

The invention is not limited to the particular arrangement of components described and shown herein. It will be understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures. Furthermore, the use of particular terms and phrases herein is for the purpose of facilitating the description of the embodiments presented and should not be regarded as limiting.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A portable electronic device comprising:
(a) a screen block having:
(1) an obverse surface comprising a main screen;
(2) a reverse surface opposing the obverse surface;
(3) opposing top and bottom surfaces; and
(4) opposing left and right surfaces;
(b) a stand block having:
(1) opposing first and second surfaces;
(2) opposing top and bottom surfaces; and
(3) opposing left and right surfaces; and
(c) a hinge pivotally connecting the screen block to the stand block, wherein the hinge is:
(1) located near one of the top, left, and right surfaces of the screen block and the corresponding surface of the stand block; and
(2) adapted to enable the portable electronic device to be in one or more closed configurations and one or more hands-free viewing configurations, wherein the portable electronic device is adapted for:
(i) handheld use; and
(ii) hands-free viewing, wherein the portable electronic device is adapted to have the bottom surfaces of the screen block and the stand block resting on a substantially horizontal surface.

2. The invention of claim 1, further comprising at least one pad on each of the bottom surfaces.

3. The invention of claim 1, wherein:
the hinge electrically connects the screen block and the stand block; and
the stand block comprises one or more electronic components of the portable electronic device.

4. The invention of claim 3, wherein the stand block is adapted to house a battery.

5. The invention of claim 3, wherein the stand block is adapted to house a non-volatile memory drive.

6. The invention of claim 1, wherein the portable electronic device comprises a keypad.

7. The invention of claim 6, wherein the keypad is located on the screen block.

8. The invention of claim 1, wherein the portable electronic device is adapted to rotate an image displayed on the main screen.

9. The invention of claim 8, wherein the portable electronic device is adapted to be in at least two hands-free viewing orientations, wherein at least two of the left surfaces, bottom surfaces, and right surfaces of the screen block and the stand block are adapted to rest on the substantially horizontal surface, and wherein the image is adapted to rotate for the different viewing orientations.

10. The invention of claim 1, wherein the portable electronic device is adapted to display video on the main screen.

11. The invention of claim 1, wherein, in a closed configuration, the second surface of the stand block is facing and abutting the obverse surface of the screen block.

12. The invention of claim I 1, wherein, in another closed configuration, the first surface of the stand block is facing and abutting the reverse surface of the screen block.

13. The invention of claim 1, wherein, in a closed configuration, the first surface of the stand block is facing and abutting the reverse surface of the screen block.

14. The invention of claim 1, wherein, in a hands-free viewing configuration, an acute angle is formed between the reverse side of the screen block and the first side of the stand block.

15. The invention of claim 1, wherein the hinge is located near one of the left and right surfaces of the screen block and the corresponding surface of the stand block.

16. The invention of claim 15, wherein the stand block is shaped such that the screen block leans back when the portable electronic device is in at least one of the hands-free viewing configurations.

17. The invention of claim 1, wherein the portable electronic device is adapted for mobile communication.

18. The invention of claim 2, wherein:
the hinge electrically connects the screen block and the stand block;
the stand block is adapted to house a battery;
the screen block comprises a keypad; and
in at least one hands-free viewing configuration, an acute angle is formed between the reverse surface of the screen block and the first surface of the stand block.

19. The invention of claim 18, wherein the hinge is located near the top surfaces of the screen block and the stand block.

20. The invention of claim 18, wherein the hinge is located near one of the left and right surfaces of the screen block and the stand block.
